(19) United States
(12) Patent Application Publication
(10) Pub. No.: US 2006/0148536 A1
(43) Pub. Date: Jul. 6, 2006

(54) Accessory fastening device for mobile unit and adapted accessory

(76) Inventors: Philippe Schoulz, Paris (FR); Richard Chen, Taipei (CN)

Correspondence Address: MICHAEL BEST & FRIEDRICH, LLP, 100 E WISCONSIN AVENUE, MILWAUKEE, WI, 53202, US

(21) Appl. No.: 10/532,204

(22) PCT Filed: Oct. 18, 2002
(86) PCT No.: PCT/FR02/03571

§ 371 Date: Jan. 26, 2006

(51) Int. Cl. H04M 1/00

(52) U.S. Cl. 455/575.1

(57) ABSTRACT

The invention seeks to enable an accessory to be attached in modular and safe manner to a mobile unit while providing a choice between at least two fastener means. An accessory attachment system for a mobile unit in accordance with the invention, in which the accessory has an anchor point for a ring on which there is mounted a loop of cord for connection to the mobile unit presents a plate suitable for being secured to the shell of the mobile unit, and at least one O-ring of elastic material suitable for sliding or rolling along the external antenna in order to take up a clamped position at the root of the antenna, the plate and the O-ring being mounted on the cord. Advantageously, the accessory and the plate are mounted on the cord via respective key rings.

The invention relates to a system for attaching one or more personalizable accessories for portable mobile units, such as cell phones, personal organizers, remote controls, roaming microcomputers, etc., and it also relates to an accessory particularly adapted to such a use.

### BACKGROUND OF THE INVENTION

Personalizable accessories have developed along with key cases. Ever since the appearance of mobile units, accessories adapted to the theme of transmission, and in particular optical transmission, have appeared, in particular emitters of laser radiation or miniature flash lamps.

Such accessories are generally secured to mobile units via an intermediate flexible element. This element, whether a cord, a clip, a soft metal flap, or any other flexible element that can be opened, is connected both to the shell of the portable unit, and to the accessory, passing through respective rings molded integrally with each of them, i.e. both the portable unit and the accessory. Such connections are generally made through at least one simple ring fixed to one end of the intermediate element. By parting the facing ends of the ring, such a simple ring makes it possible to insert a new element or to replace an existing element.

Nevertheless, such a solution does not give satisfaction in terms of security, since the intermediate element is easily opened, nor in terms of modularity, since no provision is made for fastening other than via the integrally molded ring provided for that purpose.

### OBJECTS AND SUMMARY OF THE INVENTION

To overcome those drawbacks, the invention provides the possibility of selecting the fastener means with the introduction of means suitable for co-operating with the antenna of the portable unit, and means suitable for sticking to the shell of the portable unit. The plate is selected in particular when the portable unit does not have an external antenna.

More precisely, the invention provides an accessory attachment system for a mobile unit, the mobile unit being covered in an outer shell possibly presenting an external antenna, and the accessory having an anchor point for a ring on which there is looped a cord for providing a connection with the mobile unit. The cord has mounted thereon a plate suitable for being secured to the shell and at least one O-ring of elastic material that is suitable for sliding or rolling along the external antenna in order to take up a clamped position at the root of the antenna. Advantageously, the accessory and the plate are mounted on the cord via respective key rings.

In preferred embodiments, anchoring is achieved by an overmolded toroidal section, or by two facing holes formed in parallel faces of the accessory, a double-sided strip of adhesive possibly being stuck to the plate, said strip then being covered in a protective film.

In an aspect of the invention for consideration when the mobile unit is a cellular telephone, the accessory comprises a case of plastics material housing a tuning circuit set to the frequency band used by the phone both in reception and in transmission, the circuit being coupled to a wave pickup and being designed to power at least one light-emitting diode (LED), in particular to flash whenever a calling signal is being picked up or transmitted.

In particular embodiments, the architecture of the circuit is sufficiently miniaturized and adaptable to enable main parallel faces of the accessory to take up a variety of figurative shapes, e.g. a bottle, a playing card, a face, etc. Advantageously, one main face of the accessory may be made to constitute a screen-wiper by sticking to said face a material suitable for wiping away traces of dirt left on the screen of the mobile unit.

### BRIEF DESCRIPTION OF THE DRAWING

Other characteristics and advantages of the invention appear on reading the following detailed description of an embodiment given with reference to the accompanying figures, in which:

FIG. 1 is a perspective view of an example of an attachment system of the invention for attaching an accessory to a cell phone; and

FIG. 2 is a perspective view on a larger scale showing the accessory of the FIG. 1 attachment system.

### MORE DETAILED DESCRIPTION

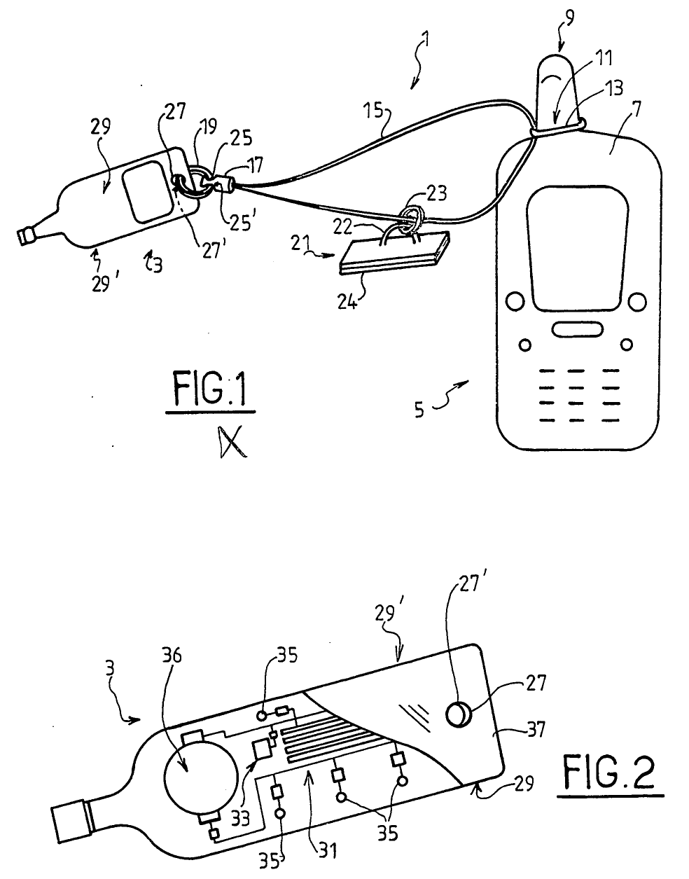

FIG. 1 shows an attachment system 1 for attaching an accessory 3 for a cell phone. The cell phone 5 has an outer shell 7 and includes an external antenna 9. At the root 11 of the antenna there is mounted an O-ring 13 which is rolled-on tight.

This O-ring 13 is made of elastic material (rubber or elastomer) and enables the accessory 3 to be mounted on the cell phone 5. It forms a portion of the attachment system 1 which also comprises a loop 15 in the form of a braided cord, and a cylindrical endpiece 17 fitted with a key ring 19 for connection to the accessory 3. The key ring is in the form of a quenched steel wire coiled to form two turns.

The cord can be mechanically connected both to the portable unit and to the accessory. At the portable unit, the O-ring 13 is looped around the strand of the cord 15 whose ends are knotted together after being passed into a narrow end of the endpiece 17 so as to form a loop.

The plate 21 presents a handle 22 for connecting to the cord 15 via another key ring 23. The plate 21 is provided as an alternative to the O-ring 13 for attaching the accessory 3 to the portable unit 5.

The O-ring 13 is suitable for sliding and/or rolling along the antenna 9 so as to be clamped tightly against the root of the antenna. The plate 21 is suitable for being secured to the shell by means of a double-sided adhesive strip that is protected in conventional manner, prior to being used, by a peel-off film 24 of flexible plastics material by way of non-limiting example.

At the accessory, the wall of the cylindrical endpiece 17 and the essentially plane opposite faces of the accessory 3 present two facing holes, respectively 25, 25′ and 27, 27′, with the key ring 19 passing through them.

As shown in FIG. 2, the accessory 3 as shown in this example is generally in the shape of a flat bottle, being made up of a shell of plastics material comprising two plane and parallel main faces 29 and 29′.

The accessory houses a tuning circuit 31 tuned to the frequency used by the portable unit in reception and in transmission. The circuit 31 is coupled to a wave pickup 33 and is designed to power LEDs 35. The components and the circuits are powered by a button cell 36 or any other suitable power supply (a rechargeable battery, a photocell, etc.).

When a call signal is picked up and/or transmitted, the circuit is adjusted so that the diodes flash, emitting light of different colors through transparent portions of a face 29. A screen wiper 37 is stuck on the other face 29′. This screen wiper is made of a material suitable for wiping traces of dirt away from the screen of the portable unit.

The invention is not limited to the embodiment described and shown. It is possible to provide a plurality of O-rings and/or fastener plates, or to make attachments to mobile units other than portables suitable for use in cellular telephony, for example digital personal assistants, portable microcomputers, or electronic dictionaries, which mobile units may optionally be adapted to send and/or receive telephone calls.

What is claimed is:

1. An accessory attachment system for a mobile unit covered in an outer shell capable of possibly presenting an external antenna, the accessory having an anchor point for a ring on which there is mounted a loop of cord for connection to the mobile unit, wherein the cord has mounted thereon a plate suitable for being secured to the shell of the mobile unit, and at least one O-ring of elastic material suitable for sliding or rolling along the external antenna to occupy a clamped position at the root of the antenna.

2. An accessory attachment system according to claim 1, in which the accessory and the plate are mounted on the cord via respective key rings.

3. An accessory attachment system according to claim 1, in which anchoring is provided either by an overmolded toroidal section or by two facing holes formed in parallel faces of the accessory.

4. An accessory attachment system according to claim 1, in which a double-sided adhesive layer is stuck to the plate, the layer being covered in a protective film.

5. An accessory attachment system according to claim 1, for use with a mobile unit for use in cellular telephony, in which the accessory comprises a case of plastics material housing a tuned circuit set to the frequency band used by the mobile unit in transmission and in reception, the circuit being coupled to a wave pickup and being designed to power at least one LED.

6. An accessory attachment system according to claim 1, in which the circuit is set so that the LEDs flash when a call signal is picked up or transmitted.

7. An accessory attachment system according to claim 5, in which the architecture of the circuit is sufficiently miniaturized and adaptable to allow main parallel faces of the accessory to take up a variety of figurative shapes.

8. An accessory attachment system according to claim 5, in which a screen wiper is formed on one of the main faces of the accessory by sticking to said face a material that is capable of wiping away traces of dirt left on the screen of the mobile unit.
